(19) United States
(12) Patent Application Publication
(10) Pub. No.: US 2013/0054448 A1
(43) Pub. Date: Feb. 28, 2013

(54) PAYMENT PROCESSING INFORMATION SYSTEM

(71) Applicants: Vipul Sardana, Hyderabad (IN); Phani Kokku, Hyderabad (IN); Veerender Singh, Hyderabad (IN); Raman Natarajan, Secunderabad (IN)

(72) Inventors: Vipul Sardana, Hyderabad (IN); Phani Kokku, Hyderabad (IN); Veerender Singh, Hyderabad (IN); Raman Natarajan, Secunderabad (IN)

(73) Assignee: Bank of America Corporation, Charlotte, NC (US)

(21) Appl. No.: 13/221,239

(22) Filed: Aug. 30, 2011

(51) Int. Cl. G06Q 20/00; G06Q 40/00

(52) U.S. Cl. 705/39

(57) ABSTRACT

A system and method for a payment processing information system is disclosed. In particular embodiments, a method for repairing payment processes of a financial institution includes receiving a first payment processing information associated with a first geographic region at a hardware processor. The method also includes receiving a second payment processing information associated with a second geographic region at the hardware processor. The method further includes receiving a request for payment processing information from a payment processor. Additionally, the method includes determining whether the payment processor is associated with a selected one of the first geographic region and the second geographic region and based on the determination, facilitating repair of a failed payment process.

### TECHNICAL FIELD OF THE INVENTION

The present disclosure relates to wire transfer information systems generally, and more particularly to a payment processing information system.

### BACKGROUND OF THE INVENTION

Payments systems frequently encounter errors of one type or another during operation. In some cases, payment system processes, such as wire transfers, may fail due to insufficient balance in a payor account, incorrect account numbers specified on a transfer request, transfers are initiated too late to be completed before specified cutoffs, and/or any cause sufficient to prevent successful completion of a payment system process. Failures such as these and others in payment system processes may require manual intervention to repair the operation before it can be completed. The rules and procedures for payment system process repair, however, may frequently change, thus leading to faulty or incomplete repair operations.

### SUMMARY OF THE INVENTION

In accordance with particular embodiments of the present disclosure, the disadvantages and problems associated with payment processing information systems have been substantially reduced or eliminated.

In accordance with a particular embodiment of the present disclosure, a method for repairing payment processes of a financial institution includes receiving a first payment processing information associated with a first geographic region at a hardware processor. The method also includes receiving a second payment processing information associated with a second geographic region at the hardware processor. The method further includes receiving a request for payment processing information from a payment processor. Additionally, the method includes determining whether the payment processor is associated with a selected one of the first geographic region and the second geographic region and based on the determination, facilitating repair of a failed payment process.

In accordance with another embodiment of the present disclosure, a system for repairing payment processes of a financial institution comprises a memory operable to store payment processing information associated with the repair of failed payment processes. The system further comprises a processor operable to receive a first payment processing information associated with a first geographic region at a hardware processor. The processor is further operable to receive a second payment processing information associated with a second geographic region at the hardware processor. The processor is also operable to receive a request for payment processing information from a payment processor. Additionally, the processor is operable to determine whether the payment processor is associated with a selected one of the first geographic region and the second geographic region and based on the determination, facilitate repair of a failed payment process.

In accordance with yet another embodiment of the present disclosure, a non-transitory computer readable medium comprises logic for repairing payment processes of a financial institution, the logic operable, when executed on a processor to receive a first payment processing information associated with a first geographic region at a hardware processor. The logic is also operable to receive a second payment processing information associated with a second geographic region at the hardware processor. The logic is further operable to receive a request for payment processing information from a payment processor. The logic is also operable to determine whether the payment processor is associated with a selected one of the first geographic region and the second geographic region and based on the determination, facilitate repair of a failed payment process.

Technical advantages provided by particular embodiments of the present disclosure may include providing to payment processors a list of sensitive clients and their standing instructions. This may enable payment processors to repair failed payment process for these clients accurately and quickly. In some embodiments, particular embodiments of the present disclosure may provide to payment processors country- and/or region-specific rules, regulations, and/or procedures to be followed to repair failed payment processes. This may ensure that payments are repaired in accordance with rules in each country or in which clients send and/or receive payments. In some embodiments, scrolling tickers are used to cascade critical information, updates and cut-off times. This may effectively communicate critical information, as it scrolls on the screen which catches the attention of payment processors. Some embodiments of the present disclosure may send email alerts regarding changes in client sensitive lists, standing instruction, updates, and/or cut-offs to payment processors, thus providing updates to payment processors without logging in to a livewire server. In general, particular embodiments of the present disclosure may enable the timely repair of failed payment processes through the processing of changes to payment procedures or cut-off times. As a result, particular embodiments of the present disclosure may provide numerous technical advantages. Particular embodiments of the present disclosure may provide some, none, all, or additional technical advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates wire transfer information system according to particular embodiments of the present disclosure;

FIG. 2 illustrates an example Graphical User Interface provided by particular embodiments of the wire transfer information system of FIG. 1;

FIG. 3 illustrates an example Graphical User Interface provided by particular embodiments of the wire transfer information system of FIG. 1; and

FIG. 4 is a flow diagram illustrating a particular operation of the system of FIG. 1 in accordance with particular embodiments of the present disclosure.

### DETAILED DESCRIPTION OF THE INVENTION

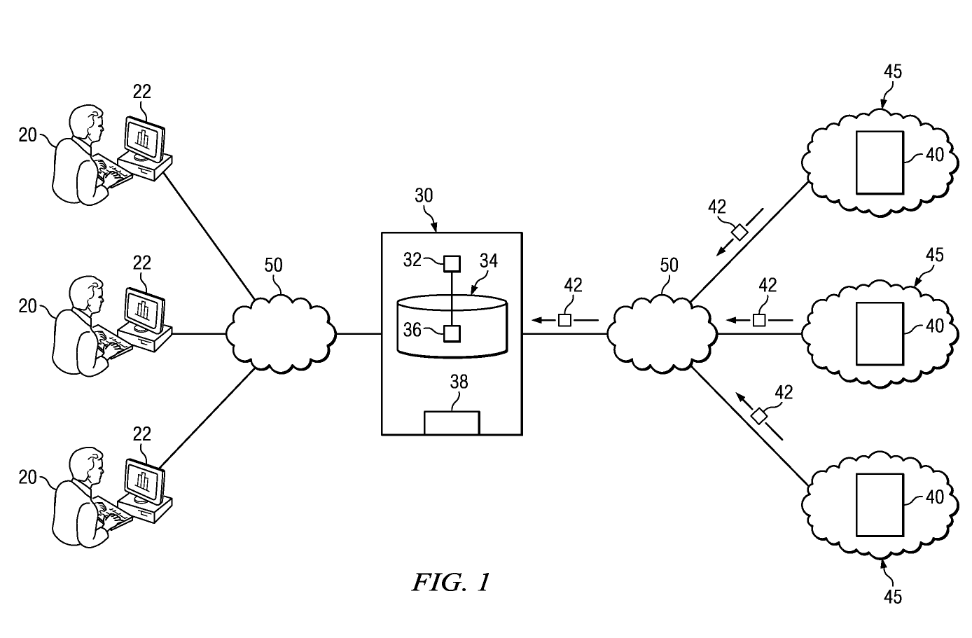

A system and method for a payment processing information system is disclosed. FIG. 1 illustrates a particular embodiment of the present disclosure that includes wire transfer information system 10, payment processors 20, livewire server 30, branches 40, network 50. In general, wire transfer information system 10 provides information on payment process instructions and facilitates repairs to failed payment processes between one or more financial institutions and their respective customers. For example, a financial institution may facilitate payments between a customer of the financial institution and a third party the customer wishes to pay. The financial institution may receive a request to remit to the third party a sum of money by a certain date and/or time, payable from the customer's account with the financial institution. The financial institution then initiates a payment process for the requested amount on behalf of the customer to the third party. Generally, this payment process is completed through an Automated Clearing House system or network, or through a wire transfer to an account held by the third party. However, in some cases the payment process may not be completed successfully. Causes of failure may include: i) an insufficient balance in a payor account at the time of the requested payment; ii) an incorrect account number specified for the third party, a maximum limit on overall transfer amounts has been reached; iii) the payment process is formatted incorrectly, and/or the payment is initiated too late to be completed before specified cutoffs. These are examples only, and numerous other causes of payment process failure exist. When a payment process, such as a wire transfer fails, it will generally be repaired by manual intervention. In particular, payment processors 20 may view the causes of the failure, review instructions or guidance on repairing the failed payment process, and initiate repairs to the payment process in accordance with the instructions or guidance, and resubmit the payment process. However, in certain embodiments, there may be numerous failed payment processes that are each waiting for repair by payment processor 20. Thus, wire transfer information system 10 provides information to payment processor 20 to facilitate repair of and prioritization of the order in which failed payment processes are repaired.

To facilitate repair of failed payment processes, wire transfer information system 10 stores various types of information related to the repair of payment processes. For example, the information may include: i) a list of clients, and corresponding standing instructions for repair of payment processes initiated by each respective client; ii) country-specific rules, regulations, and/or procedures to be followed while processing payments; iii) cut-off times by which repairs must be met for each client and/or region; and/or iv) critical updates regarding client instructions. In particular embodiments, wire transfer information system 10 may store information relevant to the repair of failed payment processes in one or more livewire servers 30. Payment processors 20 may access stored information on livewire server 30, in order to repair failed payment processes. In addition, livewire server 30 may receive updates to information stored on livewire server 30 from branches 40 in order to ensure that accurate and up-to-date information is available for payment processors 20 to repair failed payment processes.

Thus, in accordance with particular embodiments of the present disclosure, various components of wire transfer information system 10 that collectively and/or independently perform these and/or additional operations are now described with respect to FIG. 1.

Payment processors 20 represent persons who, in some embodiments, repair failed payment processes. In particular embodiments, payment processors 20 are employed, contracted, and/or otherwise utilized by a financial institution implementing an embodiment of wire transfer system 10. Payment processors 20 may communicate with livewire server 30 to obtain information on proper procedures, rules, and/or regulations on repairing particular failed payment processes. Additionally, payment processors 20 may interact with payment processing terminals 22 to repair failed payment processes.

Payment processing terminals 22 represent any computer workstation, server, and/or other computer suitable to perform the described operations. For example, in some embodiments, payment processing terminals 22 may comprise a general-purpose personal computer (PC), a Macintosh, a workstation, a Unix-based computer, a server computer, or any suitable processing device. In general, however, payment processing terminals 22 may include any appropriate combination of hardware, software, and/or encoded logic suitable to perform the described functionality. Moreover, the functions and operations described above may be performed by a pool of payment processing terminals 22.

Livewire server 30 represents one or more computer servers or server components that receive, store, aggregate, organize and/or display information related to the repair of failed payment processes. For example, livewire server 30 may receive update information 42 from branch 40. As discussed further below, update information 42 may include information relevant to repairing failed payment processes for a particular customer of a financial institution. Livewire server 42 may process update information 42 and provide information to payment processors 20 in order to facilitate the repair of failed payment processes. In particular embodiments, livewire server 30 represents a mainframe computer system that receives and/or processes data associated with particular clients, regions, payments and/or any other relevant information. In some embodiments, livewire server 30 may comprise a general-purpose personal computer (PC), a Macintosh, a workstation, a Unix-based computer, a server computer, or any suitable processing device. In general, however, livewire server 30 may include any appropriate combination of hardware, software, and/or encoded logic suitable to perform the described functionality. Moreover, the functions and operations described above may be performed by a pool of livewire servers 30.

In particular embodiments, livewire server 30 includes processor 32, memory 34, logic 36, and network interface 38. Memory 34 comprises any suitable arrangement of random access memory (RAM), read only memory (ROM), magnetic computer disk, CD-ROM, repository, other magnetic or optical storage media, or any other volatile or non-volatile memory device that stores one or more files, lists, tables, or other arrangements of information. Although FIG. 1 illustrates memory 34 as internal to livewire server 30, it should be understood that memory 34 may be internal or external to livewire server 30, depending on particular implementations. Memory 34 may be separate from or integral to other memory devices to achieve any suitable arrangement of memory devices for use in wire transfer information system 10.

Memory 34 is further operable to store logic 36. Logic 36 generally comprises rules, algorithms, code, tables, and/or other suitable instructions for performing operations described herein. Memory 34 is communicatively coupled to processor 32. Processor 32 is generally operable to execute logic to perform operations described herein. Processor 32 comprises any suitable combination of hardware and software implemented in one or more modules to provide the described function or operation.

Network interface 38 communicates information with one or more networks 50. For example, network interface 38 may communicate with wire repair terminals 22 over network 50 through network interface 38. A network may include communication using Internet protocol packets, frame relay frames, asynchronous transfer mode cells, and/or other suitable information between network addresses. A network may include one or more intranets, local area networks, metropolitan area networks, wide area networks, cellular networks, all or a portion of the Internet, and/or any other communication system or systems at one or more locations.

Branches 40 represent remote locations of a financial institution implementing particular embodiments of wire transfer information system 10. Branches 40 may be located anywhere on the globe and may communicate with one or more central locations of a financial institution over network 50. In particular embodiments, branches 40 may be organized by region. For example, one or more branches located in Europe may be designated within the financial institution as belonging to a region called “Europe.” One or more branches located in Asia may be designated within the financial institution as belonging to a region called “Asia.” In some embodiments, branches 40 include one or more associates. Associates may be assigned various roles with different levels of permissions that grant or deny an associate the ability to perform certain tasks within the financial institution. For example, a Level 1 associate may be able to view the application on a temporary basis. A Level 2 associate may be able to read, process and verify data associated with wire transfers. A Level 3 associate may update one or more web parts and data parts, and reply to queries on discussion boards. A Level 4 associate may be authorized to approve and/or delete data. In some embodiments, a Level 4 associate may represent a country head, a process manager and/or a process owner. A Level 5 associate may perform site maintenance and/or user access provisioning activities. In some embodiments, a Level 5 associate represents an administrator of wire transfer information system 10. In some embodiments, one or more of the associates are a security administrator, who have the ability to modify payment processing information in livewire server 30.

In particular embodiments, one or more associates at branch 40 may determine that a condition, parameter, and/or characteristic associated with one or more payment processes has changed. For instance, an associate may communicate with a client of the financial institution and determine that standing instructions associated with the client have been modified. As another example, an associate may determine that a cut-off time for payment processes has changed. In particular, a cut-off time for completing a wire transfer may be moved from 5 P.M. to 3 P.M., as an example. As discussed further below, information related to payment processing and/or changes in conditions associated with payment processing may be communicated as payment processing data 42 to livewire server 30.

Payment processing data 42 represents information associated with payment processing that is communicated, directly or indirectly, from branch 42 to livewire server 30. In some embodiments, payment processing data 42 may represent information embodied in an electronic mail message, an Simple Message Service text message, a telephone call, a fax, and/or any other form of communication. In particular embodiments, associates in branch 40 may communicate payment processing data 42 to a security administrator who has authority to modify payment processing information in livewire server 30. In some embodiments, associates may have the authority to communicate payment processing data 42 to livewire server 30.

Network 50 represents any number and combination of wireline and/or wireless packet-switched or circuit-switched networks suitable for data transmission. Livewire server 30, payment processing terminals 22, and/or branches 40 are communicatively coupled via one or more networks 50. In particular embodiments, payment processors 20 may communicate with livewire server 30 via payment processing terminals 22. Associates in branch 40 may communicate, directly or indirectly with livewire server 30 via one or more computers, telephones, cell phones, or other communication devices coupled to network 50. In particular embodiments, payment processing terminals 22 may communicatively couple to livewire server 30 via network 50. Network 50 may, for example, communicate interne protocol packets, frame relay frames, asynchronous transfer mode cells, and/or other suitable information between network addresses. Network 50 may include one or more intranets, local area networks, metropolitan area networks, wide area networks, cellular networks, all or a portion of the Internet, and/or any other communication system or systems at one or more locations.

Modification, additions, or omissions may be made to wire transfer information system 10 without departing form the scope of the present disclosure. For example, when a component of wire transfer information system 10 determines information, the component may determine the information locally or may receive the information from a remote location. In the illustrated embodiment, livewire server 30 and payment processing terminals 22 are represented as different components of wire transfer information system 10. However, the functions of livewire server 30 and payment processing terminals 22 may be performed by any suitable combination of one or more servers or other components at one or more locations. Additionally, livewire server 30 and payment processing terminals 22 may represent the same component within wire transfer information system 10. In the embodiment where the various components are servers, the servers may be public or private servers, and each server may be a virtual or physical server. The server may include one or more servers at the same or at remote locations. Also, livewire server 30 and payment processing terminals 22 may include any suitable component that functions as a server. Additionally, wire transfer information system 10 may include any appropriate number of livewire servers 30 and payment processing terminals 22. Any suitable logic may perform the functions of wire transfer information system 10 and the components within wire transfer information system 10.

An example operation of wire transfer information system 10 in accordance with particular embodiments of the present disclosure is now described. In particular embodiments, an associate at a first branch 40 in a first region 45 determines that payment processing information, standing orders of a particular client, and/or a cut-off time have changed. One or more associates communicate the changes by transmitting payment processing data 42 to a security administrator who has authority to modify payment processing information in livewire server 30. A security administrator may review payment processing data 42 and log in and/or otherwise communicatively couple with livewire server 30 to input changes in payment processing information embodied in payment processing data 42 into livewire server 30. In some embodiments, an associate may directly modify payment processing information in livewire server 30 by transmitting payment processing data 42 directly to livewire server 30.

Additionally or alternatively, an associate at a second branch 40 in a second region 45 determines that standing orders of a particular client and/or a cut-off time has changed. One or more associates communicate the changes by transmitting payment processing data 42 to a security administrator who has authority to modify payment processing information in livewire server 30. A security administrator may review payment processing data 42 and log in and/or otherwise communicatively couple with livewire server 30 to input changes in payment processing information embodied in payment processing data 42 into livewire server 30. In some embodiments, an associate may directly modify payment processing information in livewire server 30 by transmitting payment processing data 42 directly to livewire server 30.

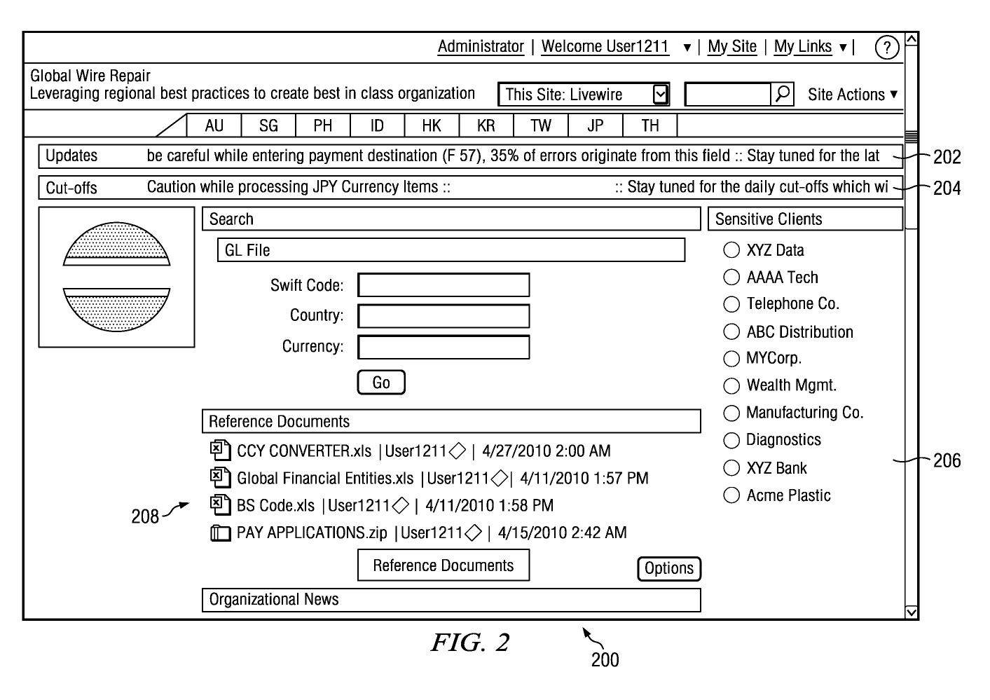

Once payment processing data 42 is transmitted and/or entered into livewire server 30 by security administrators and/or associates at branch 40, livewire server 30 processes payment processing data 42 to display changes in and/or modifications to payment processing information to payment processors 20. For example, as described further below with respect to FIG. 2, livewire server 30 may display updates to payment processing procedures and/or cut-offs in a scrolling ticker. Livewire server 30 may also display a list of sensitive clients that require heightened attention by payment processors 20. In some embodiments, changes in the list of sensitive clients may be communicated in payment processing data 42.

Payment processors 20 may log in and/or otherwise communicatively couple to livewire server 30. In particular embodiments, payment processors 20 may use payment processing terminals 22 to communicate with livewire server 30 over network 50. Payment processors 20 may view updates to payment processing information and/or cut-off times on livewire server 30 in order to repair failed payment processes. For example, livewire server 30 may display cut-off times for each of one or more clients and/or regions 45. Based on this information, payment processor 20 may prioritize the repair of failed payment process. If a cut-off time for a first failed payment process occurs sooner than a cut-off time for a second failed payment process, the first failed payment process may be repaired first. Similarly, if a first failed payment process is associated with a sensitive or priority client, and a second failed payment process is not associated with a sensitive or priority client, payment processor 20 may repair the first failed payment process first.

In some embodiments, livewire server 30 displays only country or region-specific payment processing information to payment processors 20. For example, a particular payment processor 20 may be responsible for repairing failed payment processes in China. Thus, when the particular payment processor 20 logs in to livewire server 30, livewire server 30 displays payment processing information for payments associated with China. As another example, a particular payment processor 20 may be responsible for repairing failed payment processes in a region called South America. Thus, when the particular payment processor 20 logs in to live wire server 30, livewire server 30 displays payment processing information for payments associated with the South America region.

Accordingly, by providing accurate and timely information regarding the repair of payment processes, wire information repair system 10 may provide numerous operational benefits. For example, wire information repair system 10 may provide to payment processors 20 a list of sensitive clients and their standing instructions. This may enable payment processors 20 to repair failed payment process for these clients accurately and quickly. In some embodiments, wire information repair system 10 may provide to payment processors 20 country- and/or region-specific rules, regulations, and/or procedures to be followed to repair failed payment processes. This ensures that payments are repaired in accordance with rules in each country or in which clients send and/or receive payments. In some embodiments, scrolling tickers are used to cascade critical information, updates and cut-off times. This may effectively communicate critical information, as it scrolls on the screen which catches the attention of payment processors 20. In some embodiments, wire information repair system 10 sends email alerts regarding changes in client sensitive lists, standing instruction, updates, and/or cut-offs to payment processors 20, thus providing updates to payment processors 20 without logging in to livewire server 30. In general, wire transfer information system 10 may enable the timely repair of failed payment processes through the processing of changes to payment procedures or cut-off times. As a result, wire transfer information system 10 may provide numerous operational benefits. Particular embodiments of wire transfer information system 10 may provide some, none, all, or additional operational benefits.

FIG. 2 illustrates an example graphical user interface (GUI) 200 that may be utilized in particular embodiments of wire transfer information system 10. For example, a user may utilize GUI 200 to display changes in payment processing procedures, sensitive clients, and/or cut-offs to payment processors 20. In some embodiments, GUI 200 is displayed on payment processing terminals 22 when payment processor 20 logs in to and/or otherwise communicatively couples to livewire server 30. GUI 200 may include update ticker 202, cut-off ticker 204, sensitive clients list 206, and reference documents list 208.

Update ticker 202 represents scrolling text that displays information received in payment processing data 42. For example, when payment processor 20 communicatively couples to livewire sever 30, update ticker 202 may scroll information received in payment processing data 42 since the last time payment processor 20 coupled to livewire server 30. Update ticker 202 may display changes in procedures to repair failed payment processes, alerts to indicate new reference documents have been uploaded, a change in sensitive clients list 206, and/or any other information related to the repair of failed payment processes. In some embodiments, update ticker 202 may prioritize the order of updates that it displays. For example, update ticker 202 may display information received in the most recently received payment processing data 42 first. In some embodiments, update ticker 202 may display information associated with a particular region and/or client first. In general however, update ticker 202 may display information received in payment processing information 42 in any appropriate manner, customizable according to the particular needs of an operator of wire transfer information system 10.

Cut-off ticker 204 represents scrolling text that display cut-off information received in payment processing data 42. For example, when payment processor 20 communicatively couples to livewire sever 30, cut-off ticker 202 may scroll cut-off information for failed payment processes that payment processor 20 should repair. For example, payment processing data 42 may include a cut-off time for a particular payment, client, branch, and/or region. In some embodiments, cut-off ticker 204 displays changes in cut-off times to alert payment processor 20 to the need to prioritize certain repairs of failed payment processes over others. In some embodiments, cut-off ticker 204 may prioritize the order of cut-offs that it displays. For example, cut-off ticker 204 may display information received in the most recently received payment processing data 42 first. In some embodiments, cut-off ticker 204 may display cut-offs associated with a particular region and/or client first. In general however, cut-off ticker 204 may display cut-offs received in payment processing information 42 in any appropriate manner, customizable according to the particular needs of an operator of wire transfer information system 10.

Sensitive client list 206 displays a list of sensitive clients that require heightened attention by payment processors 20. Sensitive clients may represent clients that send a large volume of transactions through a financial institution, have a large amount of deposits with a financial institution, and/or are important to the financial institution in other ways. Thus, clients listed in sensitive client list 206 may require special handling. For example, a particular payment processor tasked with repairing a number of failed payment processes may review a list of failed payment processes to determine whether any of the failed payment processes are associated with a client in sensitive client list 206. If so, payment processor 20 may process failed payment process 42 associated with heightened or special care. in a such a manner as to In some embodiments, changes in the list of sensitive clients may be communicated in payment processing data 42. Thus, sensitive client list 206 may display information received in payment processing data 42 associate with sensitive clients.

Reference documents list 208 may display document titles and/or links to documents associated with the repair of failed payment processes. For example, reference documents list 208 may display and/or link to documents detailing common procedures for repairing failed payment processes in particular regions. Reference documents list 208 may display and/or link to documents detailing cut-off times for all regions, clients, and/or branches. In some embodiments, reference documents list 208 may display and/or link to documents detailing particular client procedures, deviation procedures, and/or client lists. The above-described documents are examples, and in general, reference documents list 208 may display and/or link to any documents relevant to the repair of failed payment processes.

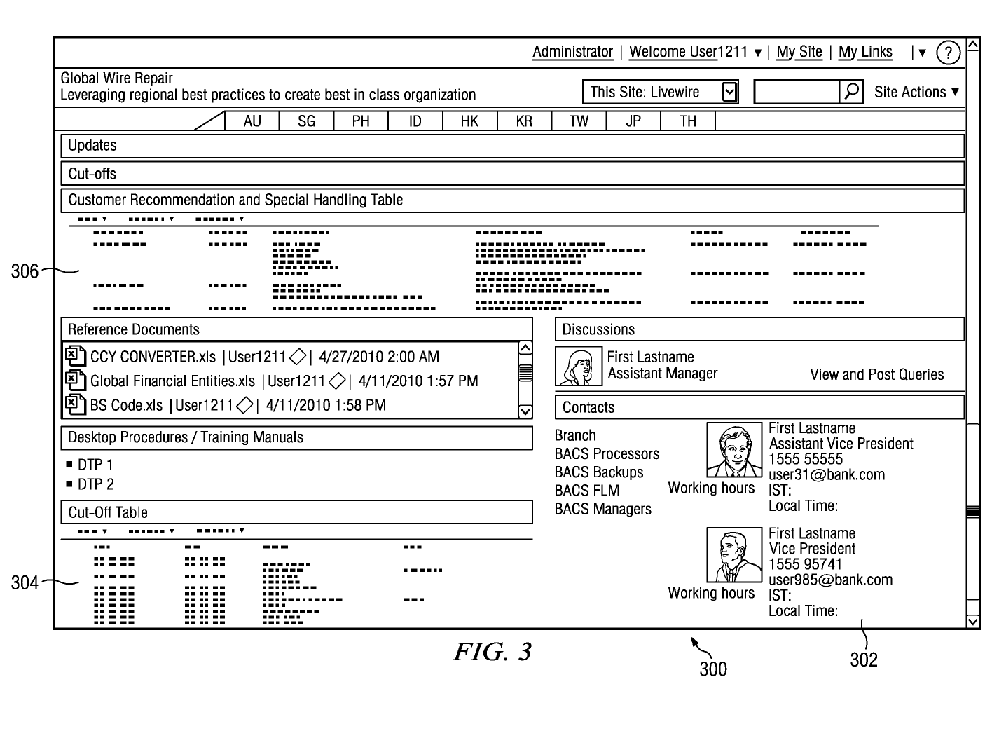

FIG. 3 illustrates an example graphical user interface (GUI) 300 that may be utilized in particular embodiments of wire transfer information system 10. In particular embodiments, payment processor 20 may log in to and/or otherwise communicatively couple with livewire server 30 to display payment processing information associated with a particular country and/or region. For example, a particular payment processor 20 may be tasked with processing payments for Australia. When payment processor 20 connects to livewire server 30 using payment processing terminals 22, livewire server 30 may present GUI 300 to payment processor 20, which includes information associated with the particular region that payment processor 20 is tasked with processing payments for. In some embodiments, GUI 300 includes contacts list 302, cut-off table 304, and special handling table 306.

Contacts list 302 may include names and contact information for persons associated with the particular country and/or region shown in GUI 300. For example, contacts list 302 may display a name and contact information for a vice president, an assistant vice president, a branch manager, and a senior manager of a particular region. In particular embodiments, contacts list 302 may include information received in payment processing data 42.

Cut-off table 304 may include cut-off times for particular clients, payments, and/or branches 40 in a particular region or country shown in GUI 300. For example, cut-off table 304 may display all cut-off times for clients in Australia.

Special handling table 306 displays special handling rules and information for particular clients. In some embodiments, certain clients may have instructions for repairing failed payment processes that deviate from accepted standards. Thus, special handling table 306 may inform payment processor 20 of special handling instructions for particular clients that are listed in special handling table 306.

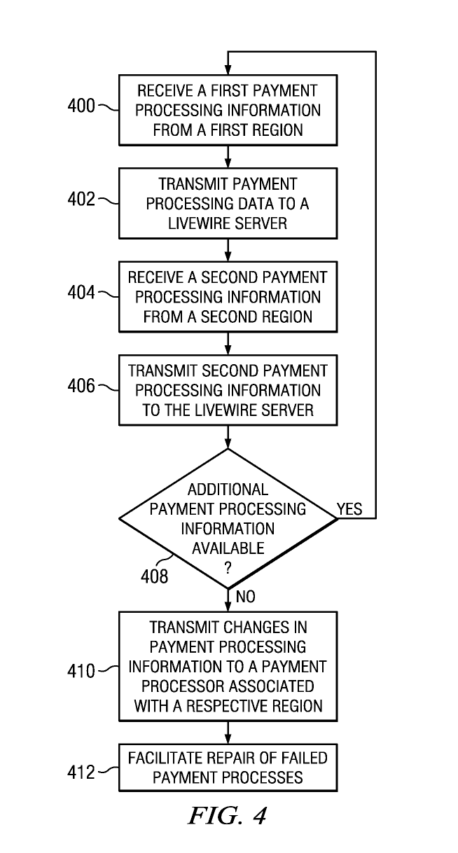

FIG. 4 is a flow diagram illustrating an operation in accordance with a particular embodiment of wire transfer information system 10. In the illustrated example, operation begins at step 400, wherein an associate at a first branch 40 in a first region 45 determines that information associated with payment processing, standing orders of a particular client and/or a cut-off time have changed.

In step 402, one or more associates communicate the changes by transmitting payment processing data 42 to a security administrator who has authority to modify payment processing information in livewire server 30. A security administrator may review payment processing data 42 and log in and/or otherwise communicatively couple with livewire server 30 to input changes in payment processing information embodied in payment processing data 42 into livewire server 30. In some embodiments, an associate may directly modify payment processing information in livewire server 30 by transmitting payment processing data 42 directly to livewire server 30.

In step 404, an associate at a second branch 40 in a second region 45 determines that information associated with payment processing, standing orders of a particular client, and/or a cut-off time has changed.

In step 406, one or more associates communicate the changes by transmitting payment processing data 42 to a security administrator who has authority to modify payment processing information in livewire server 30. A security administrator may review payment processing data 42 and log in and/or otherwise communicatively couple with livewire server 30 to input changes in payment processing information embodied in payment processing data 42 into livewire server 30. In some embodiments, an associate may directly modify payment processing information in livewire server 30 by transmitting payment processing data 42 directly to livewire server 30.

In step 408, an associate at either or both of the first branch 40 and the second branch 40 determines whether additional information associated with payment processing, standing orders of a particular client, and/or a cut-off time has changed. If so, operation returns to step 400. If not, operation proceeds to step 410. Steps 400 to 408 may be repeated until no new information regarding payment processes is available to be updated in livewire server 30.

In step 410, once payment processing data 42 is transmitted and/or entered into livewire server 30, livewire server 30 processes payment processing data 42 to display changes in and/or modifications to payment processing information to payment processors 20. For example, livewire server 30 may display updates to payment processing procedures and/or cut-offs in a scrolling ticker. Livewire server 30 may also display a list of sensitive clients that require heightened attention by payment processors 20. In some embodiments, changes in the list of sensitive clients may be communicated in payment processing data 42. payment processors 20 may log in and/or otherwise communicatively couple to livewire server 30. In particular embodiments, payment processors 20 may use payment processing terminals 22 to communicate with livewire server 30 over network 50. Payment processors 20 may view updates to payment processing information and/or cut-off times on livewire server 30 in order to repair failed payment processes. For example, livewire server 30 may display cut-off times for each of one or more clients and/or regions 45.

Based on this information, payment processor 20 may repair of failed payment process in step 412. Payment processor 20 may prioritize repair failed payment process based on information received from livewire server 30. For example, if a cut-off time for a first failed payment process occurs sooner than a cut-off time for a second failed payment process, the first failed payment process may be repaired first. Similarly, if a first failed payment process is associated with a sensitive or priority client, and a second failed payment process is not associated with a sensitive or priority client, payment processor 20 may repair the first failed payment process first.

The steps illustrated in FIG. 4 may be combined, modified, or deleted where appropriate, and additional steps may also be added to those shown. Additionally, the steps may be performed in any suitable order without departing from the scope of the present disclosure.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

1. A method for repairing payment processes of a financial institution comprising:
receiving a first payment processing information associated with a first geographic region at a hardware processor;
receiving a second payment processing information associated with a second geographic region at the hardware processor;
receiving a request for payment processing information from a payment processor;
determining whether the payment processor is associated with a selected one of the first geographic region and the second geographic region; and
based on the determination, transmitting the first payment processing information to the payment processor if the payment processor is associated with the first geographic region and the second payment processing information to the payment processor if the payment processor is associated with the second geographic region to facilitate repair of a failed payment process.

2. The method of claim 1, wherein facilitating repair of a failed payment process comprises transmitting payment processing information associated with the geographic region with which the payment processor is associated to the payment processor.

3. The method of claim 1, wherein the first and second payment processing information each comprise one or more changes to standing client instructions for repairing failed payment processes associated with the first region.

4. The method of claim 1, wherein the first and second payment processing information each comprise one or more changes to a cut-off time for repairing failed payment processes associated with the first region.

5. The method of claim 1, wherein the first and second payment processing information each comprise a change to a list of sensitive clients.

6. The method of claim 1, wherein the first and second payment processing information each comprise a list of standing instructions for processing payments for one or more clients.

7. A system for repairing payment processes of a financial institution comprising:
a memory operable to store payment processing information associated with the repair of failed payment processes; and
a processor operable to:
receive a first payment processing information associated with a first geographic region at a hardware processor;
receive a second payment processing information associated with a second geographic region at the hardware processor;
receive a request for payment processing information from a payment processor;
determine whether the payment processor is associated with a selected one of the first geographic region and the second geographic region; and
based on the determination, transmit either the first payment processing information to the payment processor if the payment processor is associated with the first geographic region or the second payment processing information to the payment processor if the payment processor is associated with the second geographic region to facilitate repair of a failed payment process.

8. The system of claim 7, wherein the processor is operable to facilitate repair of a failed payment process by transmitting payment processing information associated with the geographic region with which the payment processor is associated to the payment processor.

9. The system of claim 7, wherein the first and second payment processing information each comprise one or more changes to standing client instructions for repairing failed payment processes associated with the first region.

10. The system of claim 7, wherein the first and second payment processing information each comprise one or more changes to a cut-off time for repairing failed payment processes associated with the first region.

11. The system of claim 7, wherein the first and second payment processing information each comprise a change to a list of sensitive clients.

12. The system of claim 7, wherein the first and second payment processing information each comprise a list of standing instructions for processing payments for one or more clients.

13. A non-transitory computer readable medium comprising logic for repairing payment processes of a financial institution, the logic operable, when executed on a processor to:
receive a first payment processing information associated with a first geographic region at a hardware processor;
receive a second payment processing information associated with a second geographic region at the hardware processor;
receive a request for payment processing information from a payment processor;
determine whether the payment processor is associated with a selected one of the first geographic region and the second geographic region; and
based on the determination, transmit the first payment processing information to the payment processor if the payment processor is associated with the first geographic region and the second payment processing information to the payment processor if the payment processor is associated with the second geographic region to facilitate repair of a failed payment process.

14. The non-transitory computer readable medium of claim 13, wherein the logic is operable to facilitate repair of a failed payment process by transmitting payment processing information associated with the geographic region with which the payment processor is associated to the payment processor.

15. The non-transitory computer readable medium of claim 13, wherein the first and second payment processing information each comprise one or more changes to standing client instructions for repairing failed payment processes associated with the first region.

16. The non-transitory computer readable medium of claim 13, wherein the first and second payment processing information each comprise one or more changes to a cut-off time for repairing failed payment processes associated with the first region.

17. The non-transitory computer readable medium of claim 13, wherein the first and second payment processing information each comprise a change to a list of sensitive clients.

18. The non-transitory computer readable medium of claim 13, wherein the first and second payment processing information each comprise a list of standing instructions for processing payments for one or more clients.

19. The non-transitory computer readable medium of claim 13, wherein transmitting the first payment processing information or the second payment processing information to the payment processor comprises transmitting information for establishing priority among a plurality of failed payment processes.

20. The method of claim 1, wherein transmitting either the first payment processing information or the second payment processing information to the payment processor comprises transmitting information for establishing priority among a plurality of failed payment processes.

21. The system of claim 7, wherein, when transmitting either the first payment processing information or the second payment processing information to the payment processor, the processor is operable to transmit information for establishing priority among a plurality of failed payment processes.
